(19) United States
(12) Patent Application Publication
(10) Pub. No.: US 2007/0240164 A1
(43) Pub. Date: Oct. 11, 2007

(54) Command line pipelining

(75) Inventors: Bilal Alam, Sammamish, WA (US); Michael Volodarsky, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/376,490

(22) Filed: Mar. 15, 2006

(51) Int. Cl. G06F 9/46

(52) U.S. Cl. 719/310

(57) ABSTRACT

Piping command line functions. A method may be practiced in a computing system. The method includes acts for performing functions using a single command line utility capable of performing multiple functions. The command line utility is able to accept output of the command line utility as arguments for functions performed by the command line utility. The method includes calling a command line utility to perform a particular function. An output is received from the command line utility. The command line utility is called again using the output as an argument when calling the command line utility again.

### BACKGROUND

### BACKGROUND AND RELEVANT ART

Computers and computing systems have affected nearly every aspect of modern living. Computers are generally involved in work, recreation, healthcare, transportation, entertainment, household management, etc. To troubleshoot computing systems, a variety of tools are available to users and IT professionals. For example, many computer systems include or may be used with command line utilities that allow a user to troubleshoot various problems. A command line utility is a computer program that may be executed from a command line such as a DOS prompt.

To execute a command line utility, a user enters the name of the command line utility along with various parameters specifying inputs that the command line utility should take into account when executing. For example, “ping 192.168.0.1” is an instance of a command line utility that directs a computer system to send a generic message on a network to another computer system at the IP address 192.168.0.1 to test network connectivity between the two computer systems.

Command line utilities generally output a result to a computer screen or in some cases the command line utilities generate a log file with results. To perform additional testing, the user must generally copy the information from the computer screen or from the log file, and appropriately reformat that information if the information is to be used in a different command line utility as an input. Thus to perform multiple operations with one or more command line utilities requires a high amount of user interaction.

Other troubleshooting tools available to users and IT professionals are specialized custom scripts. Scripts are generally able to perform a series of operations. However, scripts are generally designed to perform a specific series of operations and are therefore less extensible and usable in a general context. Additionally, because of their specialized nature, the scripts are often generated by the user. Thus, the user must often possess a high level of specialized knowledge to program the scripts.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment described herein is a method that may be practiced in a computing system. The method includes acts for performing functions using a single command line utility capable of performing multiple functions. The command line utility is able to accept output of the command line utility as arguments for functions performed by the command line utility. The method includes calling a command line utility to perform a particular function. An output is received from the command line utility. The command line utility is called again using the output as an argument when calling the command line utility again.

Another method described herein may be practiced in a computing system. The method includes acts for performing functions using a single command line utility capable of performing multiple functions. The command line utility is able to accept output of the command line utility as arguments for functions performed by the command line utility. The method includes receiving a single command line statement from a user. The single command line statement includes a number of arguments specifying functions to be performed. An output is generated as the result of a first function being performed specified by at least one of the arguments. The output is used in an unmodified form as the input for performing a second function specified by at least one of the arguments.

Another method described herein may be practiced in a computing system. The method includes acts for performing functions using a single command line utility capable of performing multiple functions. The command line utility is able to accept output of the command line utility as arguments for functions performed by the command line utility. The method includes generating an output as a result of executing the command line utility to perform a first function. The method further includes piping the output in an unmodified form back to the command line utility for use in performing a second function.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an embodiment of command line pipelining;

FIG. 2 illustrates a method of using a command line utility;

FIG. 3 illustrates another method of using a command line utility; and

FIG. 4 illustrates yet another method of using a command line utility.

### DETAILED DESCRIPTION

Embodiments herein may comprise a special purpose or general-purpose computer including various computer hardware, as discussed in greater detail below.

Some embodiments disclosed herein are directed to systems and methods that allow a number of commands to be performed using a single command line utility. For example, a command line utility may include functionality that allows arguments to be nested such that the same command line utility can be used to perform a number of different functions. Additionally, resulting data produced by invocation of one of the functions can be looped back into the command line utility without additional formatting such that subsequent functions specified by arguments can be used as inputs.

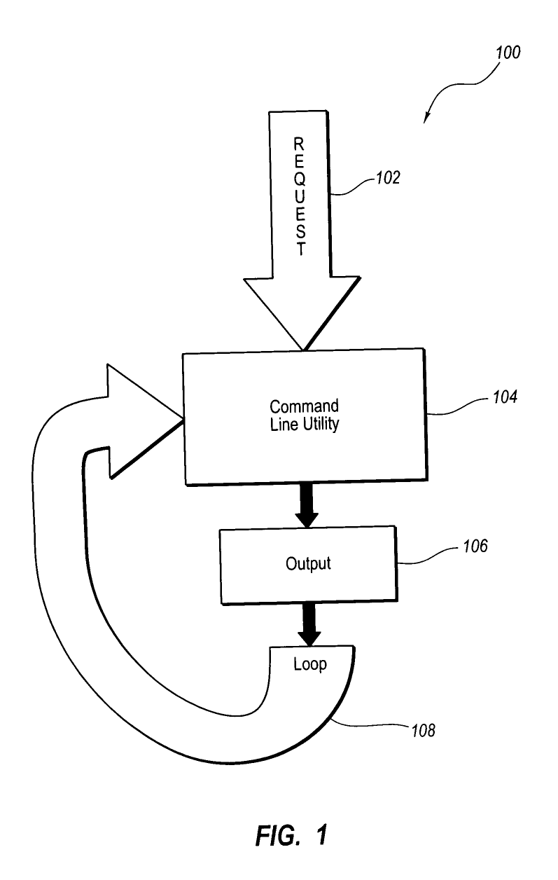

Attention is now directed to FIG. 1 where one example of a workflow pipeline 100 is illustrated. The workflow pipeline 100 illustrates a request 102. In this embodiment, the request includes a plurality of arguments. In one embodiment, the arguments may be used to specify a number of different functions that will be performed by a command line utility. FIG. 1 illustrates a command line utility 104 that receives the request 102. The command line utility 104 includes functionality for performing a function as dictated by at least one of the plurality of arguments included in the request 102. As a result of performing a function, an output 106 is generated. The workflow pipeline 100 illustrates that the output may be looped back to the command line utility 104 through a loop 108. The loop 108 is utilized if more functions are dictated such as by the inclusion of the plurality of arguments included in the request 102. As illustrated, the output 106 may be looped back to the command line utility 104 through the loop 108 such that the output 106 can be used as an input argument for another function being performed by the command line utility 104.

Referring once again to the request 102 illustrated in FIG. 1, the request 102 may be embodied in one example as a single command line statement from the user. The single command line statement may include a number of arguments which may be used to specify functions to be performed. For example, an exemplary command line statement embodying to request 102 may be formatted as follows:
Command: Find sites| Find applications
   In this particular example, the command line utility includes a function to find sites. After the sites are found, applications running on those sites will be enumerated.

In an alternative embodiment, the request 102 maybe embodied as a batch file used to provide inputs to the command line utility 104.

The command line utility 104 includes functionality for performing a number of different functions. Which function is performed may be dictated by arguments in the request 102. In one embodiment, the command line utility 104 may be designed to perform a number of inter-related functions such that the same command line utility can be used when accomplishing a more complex larger overall operation. For example, in a server control context, the command line utility may include functions that provide functionality for finding web sites serving a particular IP address or range of addresses. The command line utility 104 related to the server context may further include functionality for stopping web sites. Thus, a user may provide a request 102 to the command line utility that indicates that the command line utility should find web sites and then stop the found web sites. As will be described in more detail below, the output from the find web sites function can be used as an input to the command line utility when the stop web sites function is performed by the command line utility 104.

As more illustrative examples, the following scenarios of single more complex operations comprised of multiple piped commands are illustrated. A first example includes finding a set of object instances and then performing an operation on those instances. For example a first command may find sites listening on a particular IP address where a second command using the output form the first command stops the sites. A second example includes finding a set of object instances related to another object where a relationship exists between multiple objects. For example a piped commands find virtual directories belonging to the applications that belong to sites that currently have executing requests that have executed for over 10 seconds. A third example includes performing a batch operation on many objects efficiently. For examples command line piping allows for finding all sites that satisfy a particular criteria, and stopping them.

This flexibility allows complex end to end management scenarios to be easily performed at a command line without investing in complex scripting code that executes multiple commands, and keeps intermediate state to essentially achieve the same goals, which is not accessible to most server customers due to complexity involved.

Computer systems, frameworks, applications and the like may expose a basic set of management objects that can be used to interact with basic structural components. For example, in the server context, a server may expose the concepts of Sites, Applications, Virtual Directories, Configuration sections, etc. Each object provides a set of supported functions that can be used to interact with the object. For example functions may be used for creating an application, setting configuration properties of a configuration section, or stopping a site, etc. Each object may also provide the ability to enumerate instances of that object that exist, possibly via a query based on various properties of the instance requested.

The command line utility 104 may include functions for exposing an interface with an object to the command line user enabling the ability to execute the functions on the desired object instances.

As described previously, the command line utility 104 includes functionality for performing a plurality of functions. This allows the same command line utility 104 to be used to appropriately interface with the objects applicable to a given system, framework, application, etc. Additionally, the command line utility 104 includes the ability to accept outputs for preceding functions as inputs to subsequent functions performed by the command line utility 104.

Referring once again to FIG. 1, an output 106 is illustrated. In one embodiment, the output 106 maybe embodied as an XML data set. As illustrated, the output 106 may be piped back to the command line utility 104 using a loop 108. As such, subsequent functions performed by the command line utility 104 can use the output 106 generated by preceding function as well as arguments specified in the request 102 to perform subsequent functions.

As explained, the output 106 may be an XML data set. For example, the following arguments may input by a user:
Command: Find sites| Find applications

The Find sites function may produce a set of XML elements each describing a site element found by the function. For example, an output of a command line utility 104 where the command line utility has a “Find sites” argument may return the following XML data set:
<data>

<site id=“5” name=“MySite” binding=“localhost:80”/<

<site id=“10” name=“SecureSite” binding=“localhost:443”/>
</data>

In the particular example illustrated, the “Find applications” function accepts the XML output above generated by the “Find sites” function, and executes the “Find applications” function for each of the sites identified by the “Find sites” function where each site is used as an argument for the “Find applications” function. In this case, each of the “Find applications” functions produces a set of applications related to the site id identified in the XML. The resulting set of applications may be merged and output as a result of the two function chain including the “Find site” function and the “Find applications” function. Additionally, this output could be piped to yet another function, either by extending the original command line entered by the user or by a subsequent command line to perform an operation on the set of applications computed by the chain. For example, the command line entry may include an argument to set a property on an application.

In one embodiment STDIN and STDOUT (standard input and standard output respectively) streams are used for input and output respectively of the XML data. This ensures that piping can be easily done using the command line utility 104 by using shell piping mechanisms. Additionally, the use of STDIN and STDOUT streams also allows the output 106 to be redirected to a file or read from a file. This allows the output 106 to be stored such that intermediate results can be used later or on another machine.

For example, in one embodiment, a set of applications on one system can be exported to another system. The output 106 of a commend line utility 104 can be redirected to an XML file. The XML file can be copied to the other system where the applications have been exported. The command line utility 104 can then be run at the other system with the input including the XML file to restore the applications.

The STDIN/STDOUT designed with an XML format allows the data to be sent to and from other tools that process XML, such as ADO.NET, XSLT transformation for report generation, etc. For example, the XML data sets may be used with Web services applications. Web Services is a standardized way of integrating applications. Standardized XML documents can be used with SOAP (Simple Object Access Protocol) messages and WSDL (Web Services Description Language) descriptions to integrate applications without an extensive knowledge of the applications being integrated.

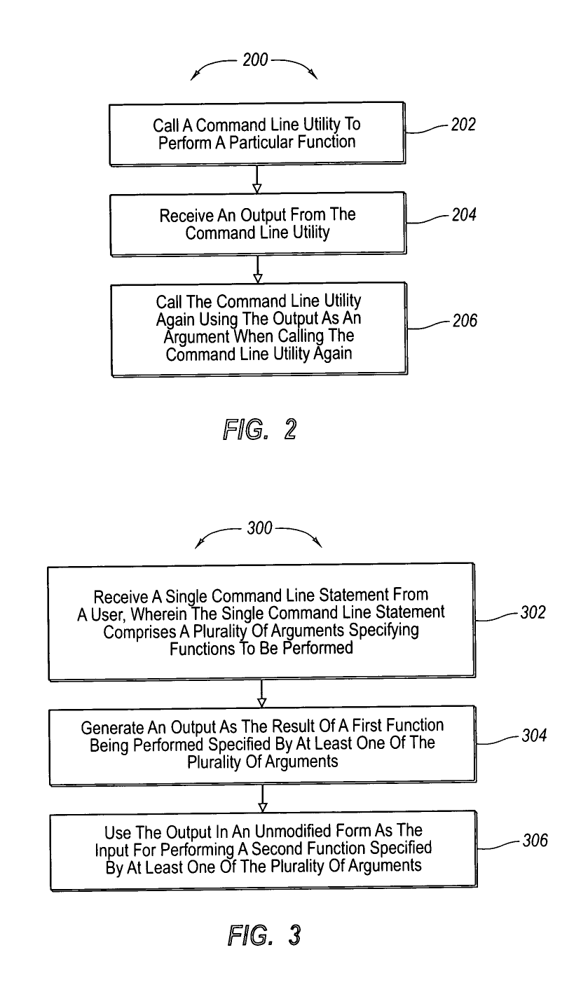

Referring now to FIG. 2, a method 200 is illustrated. The method 200 may be practiced for example in a computing system. The method is a method of performing functions using a single command line utility capable of performing multiple functions. The command line utility is able to accept output of the command line utility as arguments for functions performed by the command line utility. In one embodiment, the command line utility is designed to perform a plurality of functions for performing server management.

The method includes calling a command line utility to perform a particular function (act 202). For example, a request 102 as shown in FIG. 1 may be input into the command line utility 104 to cause the command line utility 104 to perform a particular function.

The method 200 further includes receiving an output from the command line utility (act 204). In one embodiment receiving an output includes receiving a mark-up document. For example, as explained previously herein output from the command line utility may be in the form of mark-up documents such as XML documents.

The method 200 further includes calling the command line utility again using the output as an argument when calling the command line utility again (act 206). Calling the command line utility again may be, for example, to perform a different function than the particular function for which the command line utility was originally called to perform. In some embodiments calling the command line utility again using the output as an argument when calling the command line utility again may be performed at a different machine than the machine calling a command line utility to perform a particular function. For example, as explained previously, the output may be redirected to an XML file which is copied to another machine. The command line utility may then be called at the different machine to perform the act of calling the command line utility again.

In the examples illustrated herein calling a command line utility (act 202) and calling the command line utility again (act 204) may include executing a single command line statement. The single command line statement may include arguments directing the command line utility to be called and to be called again. In alternative embodiments, calling a command line utility and calling the command line utility again may include executing a batch file with the command line utility referenced twice in the batch file.

The method 200 may further include saving the output to storage. As explained previously, the output may be directed to an XML file. The XML file may be stored locally, such as on a hard disk drive or other storage. Alternatively, the output may be transferred to another computer system for use at the other computer system. Further still, the output may be made available via network storage or sharing to permit the output to be accessed by network connected systems. The method 200 may also include transferring the output using Web Services.

Referring now to FIG. 3, another method 300 is illustrated. The method may be practiced for example in a computing system. The method is a method of performing functions using a single command line utility capable of performing multiple functions. The command line utility is able to accept output of the command line utility as arguments for functions performed by the command line utility. The method includes receiving the single command line statement from a user (act to 302). The single command line statement includes a number of arguments specifying functions to be performed.

The method 300 further includes generating an output as the result of a first function being performed specified by at least one of the arguments (act 304). Generating an output may include, for example, generating a mark-up document. Examples of mark-up document outputs are illustrated above. In one embodiment, generating an output may include streaming the output in an STDOUT stream. As noted previously, using a STDOUT stream may be useful for storing the output to an external location. For example, the method 300 may further include storing the output in a file. In one embodiment, this may be accomplished through the use of a STDOUT stream.

The method further includes using the output in an unmodified form as the input for performing a second function specified by one or more of the arguments (act 306). In one embodiment, using the output include streaming the output in an STDIN stream. Thus, for example, if the output is stored in an external location, the output can be used by a computer system by streaming the output into the computer system through an STDIN stream.

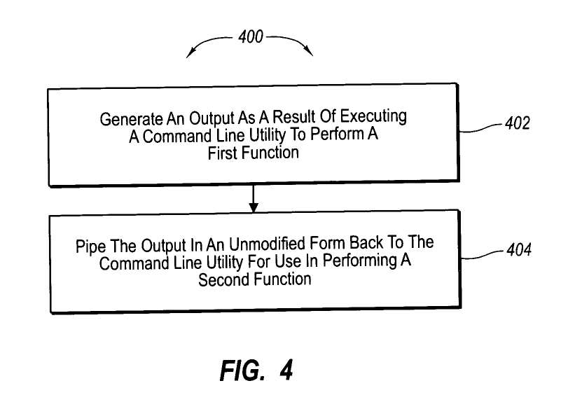

Referring now to FIG. 4, another method 400 is illustrated. The method 400 may be practiced for example in a computing system. The method 400 includes acts for performing functions using a single command line utility capable of performing multiple functions. The command line utility is able to accept output of the command line utility as arguments for functions performed by the command line utility. The method generates an output as a result of executing the command line utility to perform a first function (act 402). Generating an output may include in one example generating a mark-up document.

The method further includes piping the output in an unmodified form back to the command line utility for use in performing a second function (act 404). Piping the output in an unmodified form back to the command line utility may include piping an STDIN stream. In one embodiment, piping the output in an unmodified form back to the command line utility may include transferring the output using Web Services.

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing system, a method of performing functions using a single command line utility capable of performing multiple functions, wherein the command line utility is able to accept output of the command line utility as arguments for functions performed by the command line utility, the method comprising acts of:
calling a command line utility to perform a particular function;
receiving an output from the command line utility; and
calling the command line utility again using the output as an argument when calling the command line utility again.

2. The method of claim 1, wherein calling the command line utility again is to perform a different function than the particular function for which the command line utility was originally called to perform.

3. The method of claim 1, wherein receiving an output comprises receiving a mark-up document.

4. The method of claim 1, wherein calling a command line utility and calling the command line utility again comprise executing a single command line statement including arguments directing the command line utility to be called and to be called again.

5. The method of claim 1, wherein calling a command line utility and calling the command line utility again comprise executing a batch file.

6. The method of claim 1, further comprising saving the output to storage.

7. The method of claim 6, wherein calling the command line utility again using the output as an argument when calling the command line utility again is performed at a different machine than the machine calling a command line utility to perform a particular function.

8. The method of claim 1, further comprising transferring the output using Web Services.

9. The method of claim 1, wherein calling the command line utility again using the output as an argument when calling the command line utility again comprises calling the command line utility again to perform a related function to the particular function performed when the command line utility is first called so as to perform an overall more complex operation.

10. In a computing system, a method of performing functions using a single command line utility capable of performing multiple functions, wherein the command line utility is able to accept output of the command line utility as arguments for functions performed by the command line utility, the method comprising acts of:
receiving a single command line statement from a user, wherein the single command line statement comprises a plurality of arguments specifying functions to be performed;
generating an output as the result of a first function being performed specified by at least one of the plurality of arguments; and
using the output in an unmodified form as the input for performing a second function specified by at least one of the plurality of arguments.

11. The method of claim 10, wherein generating an output comprises generating a mark-up document.

12. The method of claim 10, further comprising storing the output in a file.

13. The method of claim 10, wherein generating an output comprises streaming the output in an STDOUT stream.

14. The method of claim 10, wherein using the output comprises streaming the output in an STDIN stream.

15. A computer readable medium comprising computer executable instruction for performing the acts of claim 10.

16. In a computing system, a method of performing functions using a single command line utility capable of performing multiple functions, wherein the command line utility is able to accept output of the command line utility as arguments for functions performed by the command line utility, the method comprising acts of:
generating an output as a result of executing the command line utility to perform a first function; and
piping the output in an unmodified form back to the command line utility for use in performing a second function.

17. The method of claim 16, wherein piping the output in an unmodified form back to the command line utility comprises piping an STDIN stream.

18. A computer readable medium comprising computer executable instruction for performing the acts of claim 16.

19. The method of claim 16, wherein generating an output comprises generating a mark-up document.

20. The method of claim 16, wherein piping the output in an unmodified form back to the command line utility comprises transferring the output using Web Services.
